(19) United States
(12) Patent Application Publication
(10) Pub. No.: US 2022/0320778 A1
(43) Pub. Date: Oct. 6, 2022

(54) CONTACT AND CONNECTOR

(71) Applicant: TYCO ELECTRONICS JAPAN G.K., Kawasaki-shi (JP)

(72) Inventor: Seiji Komatsu, Aichi (JP)

(21) Appl. No.: 17/701,248

(22) Filed: Mar. 22, 2022

(30) Foreign Application Priority Data
Mar. 31, 2021 (JP) 2021-059565

(51) Int. Cl. H01R 13/24

(52) U.S. Cl. CPC H01R 13/2435; H01R 13/2457

(57) ABSTRACT

A contact 2 shaped like a plate forming a first socket 201 and a second socket 202 for use in mating includes a first mating portion 21 that constitutes the first socket 201 and that is positioned toward a first side Si with respect to a reference position A, a second mating portion 22 that constitutes the second socket 202 and that is positioned toward a second side S2 with respect to the reference position A, and a connecting portion 23 that is positioned at the reference position A and that connects the first mating portion 21 and the second mating portion 22 to each other. The contact 2 is allowed to be displaced with respect to an engaging pin 111 in both a direction of rotation D1 on a first axis line L1 set along a plate thickness direction (z direction) of the contact 2 at the reference position A and a direction D2 parallel with a second axis line L2 diving the first side Si and the second side S2 from each other at the reference position A. The engaging pin 111 engages with the connecting portion 23.

### CROSS REFERENCE TO RELATED APPLICATIONS

This application claims priority to JP Application No. 2021-059565, filed 31 Mar. 2021, the subject matter of which is herein incorporated by reference in its entirety.

### BACKGROUND

The subject matter herein relates generally to a contact including a socket and to an electric connector including the contact.

JP4-011346UM-B discloses a connector including a plurality of identically-shaped contacts each having a pair of spring beams formed at each of both ends thereof and a housing retaining those contacts. The pair of beams form a socket that receives a mating partner. For example, a pin contact of a substrate connector is mated with the socket at one end, and a flexible substrate is mated with the socket at the other end together with a supporting element. The contacts of JP4-011346UM-B are accommodated separately in each of a plurality of cavities of the housing, and are each equivalent to one position. Accordingly, JP4-011346UM-B discloses a multipole connector.

Meanwhile, JP2019-523537T discloses a header connector including a stacked body made from a plurality of contacts each having a pair of spring beams formed at each of both ends thereof and a housing retaining the stacked body made from the contacts. The plurality of contacts stacked are equivalent to one position as a whole.

Each of the contacts described in JP4-0113461.1M-B and JP2019-523537T is retained in a predetermined position by the housing. However, great variations in the relative position of a socket formed by a contact and a mating partner, if any, make it difficult for the socket and the mating partner to be mated with each other. Even if the socket and the mating partner can be mated with each other at all, it is necessary to prevent the socket from being subjected to excessive load.

There is a need to improve the structure of a contact forming a socket and the structure of a connector.

### BRIEF DESCRIPTION

In one embodiment, a contact is provided including a contact shaped like a plate forming a first socket and a second socket for use in mating, and includes a first mating portion that constitutes the first socket and that is positioned toward a first side with respect to a reference position, a second mating portion that constitutes the second socket and that is positioned toward a second side with respect to the reference position, and a connecting portion, positioned at the reference position, that connects the first mating portion and the second mating portion to each other.

In various embodiments, the contact may be allowed to be displaced with respect to an engaging portion in both a direction of rotation on a first axis line set along a plate thickness direction of the contact at the reference position and a direction parallel with a second axis line diving the first side and the second side from each other at the reference position. The engaging portion may engage with the connecting portion.

In various embodiments, the connecting portion may have formed therein a long hole that includes the reference position and that is long in the direction parallel with the second axis line.

In various embodiments, the first mating portion may be an elastic body including a first pair of beams that retain a first mating partner therebetween and include a first contact portion that makes contact with the first mating partner and a first guide portion that guides the first mating partner toward the first contact portion, that the second mating portion be an elastic body including a second pair of beams that retain a second mating partner therebetween and include a second contact portion that makes contact with the second mating partner and a second guide portion that guides the second mating partner toward the second contact portion, that a dimension of the first guide portion between the first pair of beams increase in the direction parallel with the second axis line away from the first contact portion, and that a dimension of the second guide portion between the second pair of beams increase in the direction parallel with the second axis line away from the second contact portion.

In various embodiments, the first pair of beams may smoothly curve convexly toward each other at the first contact portion and that the second pair of beams smoothly curve convexly toward each other at the second contact portion.

In another embodiment, a connector is provided including the aforementioned contact including a single contact or a plurality of contacts forming the first socket and the second socket in a stacked state and a housing retaining the contact. The housing includes a cavity that accommodates the contact and the engaging portion that engages with the connecting portion of the contact.

In various embodiments, the connecting portion may have formed therein a long hole that includes the reference position and that is long in the direction parallel with the second axis line and that the engaging portion is equivalent to a pin that is inserted into the long hole.

In various embodiments, the housing may include a first opening through which a first mating partner corresponding to the first mating portion is inserted and a second opening through which a second mating partner corresponding to the second mating portion is inserted.

In various embodiments, the housing may include a regulating portion that regulates a displacement of the contact in the direction of rotation on the first axis line within a certain range by coming into contact with the contact and that regulates a displacement of the contact in a direction parallel with the second axis line by coming into contact with the contact.

In various embodiments, the housing may include a first opening through which a first mating partner corresponding to the first mating portion is inserted and a second opening through which a second mating partner corresponding to the second mating portion is inserted, that in a first contact portion equivalent to a contact point of the first mating portion, a first gap into which the first mating partner is inserted be set, that in a second contact portion equivalent to a contact point of the second mating portion, a second gap into which the second mating partner is inserted be set, and that regulating the displacement of the contact through the regulating portion cause a range of motion of a leading end of the first mating portion to be set outside a range of projection of the first opening and cause a range of motion of a leading end of the second mating portion to be set outside a range of projection of the second opening.

In another embodiment, a contact assembly is provided including the aforementioned contact including a plurality of contacts forming the first socket and the second socket in a stacked state and a support medium that includes the engaging portion and, by being assembled to the connecting portions of the plurality of contacts, maintains the contacts in a stacked state.

In various embodiments, the contact may be displaced with respect to the engaging portion in the direction of rotation on the first axis line and the direction (direction of slide) parallel with the second axis line, thereby making it possible to absorb tolerances of dimensional shape and assembly of the contact, the mating partners, or other components. This makes it possible to, while preventing the contact and the mating partners from being subjected to excessive load, stably connect the mating partners to the first mating portion and the second mating portion, respectively.

### BRIEF DESCRIPTION OF THE DRAWINGS

FIG. 1(a) is an isometric view of a connector in accordance with an exemplary embodiment with a lid removed from a body of a housing.

FIG. 1 (b) a side view of the connector in accordance with an exemplary embodiment viewed from the direction of an arrow 1b shown in FIG. 1(a).

FIG. 2 is a cross sectional view of the connector in accordance with an exemplary embodiment as taken along line Ia-Ia in FIG. 4(c).

FIG. 3 is a cross sectional view of the connector in accordance with an exemplary embodiment showing positions, directions, and amounts of displacement.

FIG. 4(a) is an isometric view of the connector as a whole in accordance with an exemplary embodiment.

FIG. 4(b) is a side view of the connector as seen from the direction of an arrow 4b shown in FIG. 4(a).

FIG. 4(c) a side view of the connector as seen from the direction of an arrow 4c shown in FIG. 4(a).

FIG. 5(a) is a diagram showing a range of motion of leading ends of beams of a contact and a range of projection of an opening of the housing in accordance with an exemplary embodiment.

FIG. 5(b) is a diagram for explaining an example of a process by which a mating partner is inserted into a socket formed by the contact in accordance with an exemplary embodiment.

FIG. 6 is a top view showing a state in which mating partners are inserted in sockets at both ends of contacts, respectively, in accordance with an exemplary embodiment.

FIG. 7(a) is a top view of a stacked body made from contacts in accordance with an exemplary embodiment.

FIG. 7(b) a side view of the stacked body made from the contacts in accordance with an exemplary embodiment.

### DETAILED DESCRIPTION

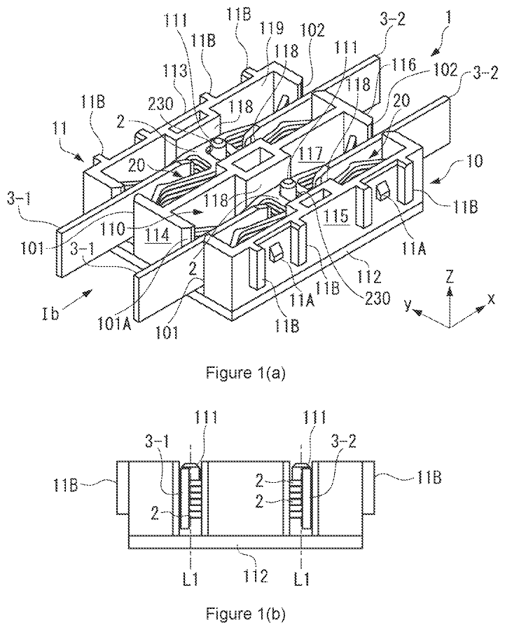

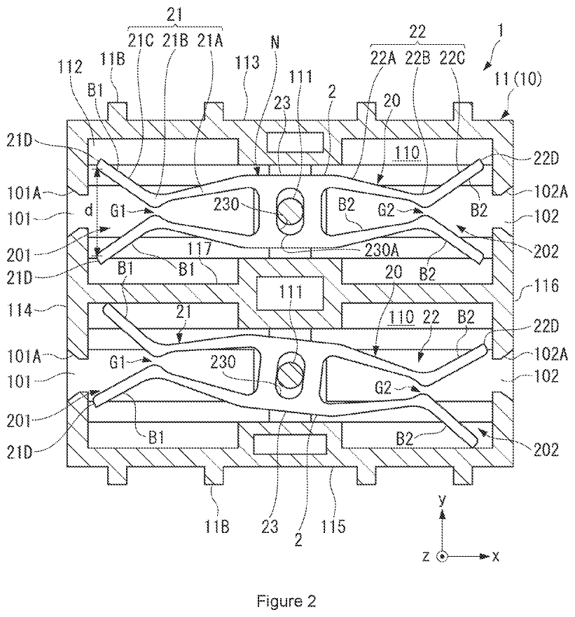

As shown in FIGS. 1 to 4, a connector 1 includes a plurality of plate-like contacts 2 (FIG. 2) stacked and a housing 10 retaining the stacked contacts 2. The connector 1 can be used, for example, in a power carrier circuit that is mounted in a vehicle or other machines.

In an exemplary embodiment, the contacts 2 of the connector 1 are used for mating with appropriate mating partners 3-1 and 3-2 such as bus bars, circuit boards, and pin-shaped or tab-shaped contacts in a stacked state. The mating partners 3-1 and 3-2 are provided in appropriate supporting elements such as device chassis. The contacts 2 form first sockets 201 and second sockets 202 as a whole in a stacked state. The first sockets 201 receive the first mating partners 3-1. The second sockets 202 receive the second mating partners 3-2.

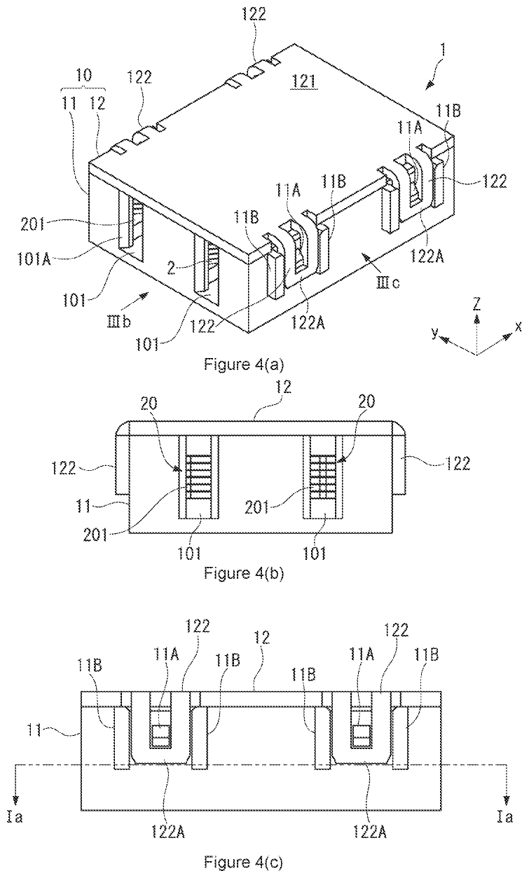

In an exemplary embodiment, the housing 10 includes a housing body 11 and a lid 12 (FIGS. 4(a) and 4(b)) assembled to the housing body 11. The housing body 11 and the lid 12 are each formed by injection molding involving the use of an insulating resin material. The housing 10 is formed in the shape of a cuboid as a whole.

The housing body 11 includes two cavities 110 each of which accommodates a stacked body 20 formed by the contacts 2 being stacked and an engaging pin 111, positioned in each of the cavities 110, that engages with the contacts 2 of the stacked body 20. Alternatively, the housing body 11 may include a single cavity 110 in which a stacked body 20 is accommodated.

The housing body 11 is formed in the shape of a box by a rectangular lower wall 112 and side walls 113 to 116 standing from the four sides, respectively, of the lower wall 112. The side walls 113 and 115 correspond to the long sides of the lower wall 112. The side walls 114 and 116 correspond to the short sides of the lower wall 112.

The interior of the housing body 11 is divided into the two cavities 110 by a dividing wall 117 set parallel to the side walls 113 and 115.

Each of the cavities 110 is given a length, a width, and a height that are needed to accommodate the whole of the stacked body 20. Assume that directions parallel with the length, width, and height of each of the cavities 110 are represented by x, y, and z, respectively. The two cavities 110 are arranged in the y direction.

In each of the cavities 110, the contacts 2 are stacked in the z direction. The engaging pin 111, which stands in the z direction perpendicular to the lower wall 112, passes through the contacts 2 in a plate thickness direction.

In an exemplary embodiment, the contacts 2 are allowed to be displaced with respect to the engaging pin 111. The housing body 11 is equivalent to a regulating portion that regulates displacements of the contacts 2 in a direction of rotation D1 within a certain range by coming into contact with the contacts 2 and that regulates displacements of the contacts 2 in a direction of slide D2 by coming into contact with the contacts 2. In an exemplary embodiment, the housing body 11 includes the side walls 113 and 115, the dividing wall 17, and a regulating element 118 as a plurality of regulating elements.

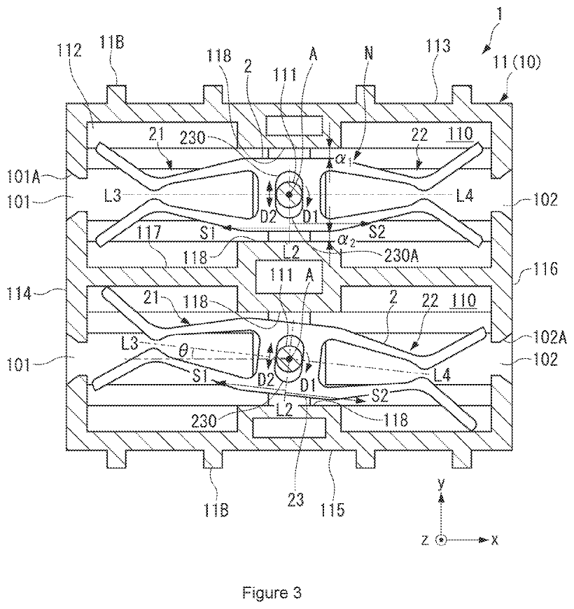

The side walls 113 and 115 and the dividing wall 17 are equivalent to a first regulating element that regulates the displacements of the contacts 2. Formed near a central part of each of the cavities 110 in the x direction are a pair of second regulating elements 118 (FIG. 3) that are parallel to the x direction and that stand in the z direction with respect to the lower wall 12. The regulating elements 118 are positioned on both sides of the contacts 2 in the y direction.

The lid 12 is formed in a rectangular shape, and includes a cover portion 121 and a plurality of lock portions 122. The cover portion 121 covers an opening 119 of the housing body 11. The plurality of lock portions 122 correspond to a plurality of locking projections 11A provided on the side walls 113 and 115 of the housing body 11. Each of the projections 11A is provided between ribs 11B that guide a corresponding one of the lock portions 122 in the z direction.

When each of the lock portions 122 is warped so that a leading end portion 122A of the lock portion 122 catches a corresponding one of the projections 11A, the lid 12 is assembled to the housing body 11. This causes a leading end portion of the engaging pin 111 to engage with the cover portion 121 (see FIG. 4(b)), which is positioned parallel to the lower wall 112, so that the engaging pin 111 keeps the contacts 2 stacked.

In the side walls 114, which is orthogonal to the x direction, two first openings 101 corresponding to the respective first sockets 201 of the two stacked bodies 20 are formed in a row in the y direction. Similarly, in the side wall 116, which is orthogonal to the x direction, two second openings 102 corresponding to the respective second sockets 202 of the two stacked bodies 20 are formed in a row in they direction.

The first openings 101 are formed with a constant width over the entire height of the side wall 114. The same applies to the second openings 102 formed in the side wall 116.

From outside the housing body 11, the first mating partners 3-1 are inserted into the first sockets 201 via the first openings 101, and the second mating partners 3-2 are inserted into the second sockets 202 via the second openings 102.

The first openings 101 pass though the side wall 114 in the x direction. The first openings 101 have guide surfaces 101A that guide the first mating partners 3-1 into the cavities 110. The guide surfaces 101A are formed such that the widths of the first openings 101 become gradually greater from the cavities 110 toward an outer surface of the side wall 114.

The second openings 102, which pass through the side wall 116 in the x direction, too have similar guide surfaces 102A.

In an exemplary embodiment, as shown in FIGS. 2 and 3, each of the contacts 2 includes a first mating portion 21 that constitutes the first socket 201, a second mating portion 22 that constitutes the second socket 202, and a connecting portion 23, positioned at a reference position A of the contact 2, that connects the first mating portion 21 and the second mating portion 22 to each other. For example, the reference position A is equivalent to a shaft center of the aforementioned engaging pin 111. In an exemplary embodiment, the reference position A be located in the center of the cavity 110 in a top view of the housing 10. The connecting portion 23 engages with the engaging pin 111.

The contact 2 is integrally formed by punching of a plate material composed of a metal material such as an aluminum alloy or a copper alloy. Each of the stacked bodies 20 are formed by stacking identically-shaped contacts 2 into a state in which flat and smooth surfaces are joined on top of each other.

At the reference position A, a first axis line L1 (FIG. 1(b)) parallel to the z direction, which is a plate thickness direction (stacking direction) of the contact 2, is set. Further, at the reference position A, a second axis line L2 dividing a first side to which the first socket 201 is directed (first side S1) and a second side to which the second socket 202 is directed (second side S2) from each other is set (FIG. 3).

The first mating portion 21 is positioned toward the first side S1 with respect to the reference position A. The second mating portion 22 is positioned toward the second side S2 with respect to the reference position A.

The connecting portion 23 has formed therein a long hole 230 that includes the reference position A and that is long in a direction parallel with the second axis line L2. The long hole 230 is located in the center of the connecting portion 23, which is formed in a substantially rectangular shape. Into the long hole 230, the engaging pin 111, which is circular in cross-section, is inserted. The diameter of the engaging pin 111 is constant over a range within which the engaging pin 111 passes through inside the long holes 230 of the contacts 2 stacked.

An end portion 230A of the long hole 230 in the direction parallel with the second axis line L2 is formed in, but is not limited to, an arc shape. The long hole 230 may be formed, for example, in a rectangular shape as a whole.

The diameter of the engaging pin 111 is shorter than the length of the long hole 230, and the width dimension of the long hole 230 in a direction orthogonal to the second axis line L2 and the diameter of the engaging pin 111 are equal to each other. There are clearances between portions of an inner peripheral edge of the long hole 230 that are parallel to the second axis line L2 and an outer peripheral portion of the engaging pin 111.

If the hole of the contact 2 through which the engaging pin 111 is passed is a circular hole and the connecting portion 23 is tightly positioned between the regulating elements 118, the contact 2 and the housing 10 are integrated in a rigidly-connected state. In that case, the contact 2 has no degree of freedom of position with respect to mating partners 3-1 and 3-2 that are inserted into the cavity 110 through the openings 101 and 102 of the housing 10.

In an exemplary embodiment, the engagement of the engaging pin 111 with the long hole 230 and the presence of a space in the cavity 110 in which the contact 2 is allowed to move give the contact 2 a degree of freedom of position. The cavity 110 includes the respective ranges of motion (ranges of movement) of the connecting portion 23, the first mating portion 21, and the second mating portion 22.

Based on the degree of freedom of position of the contact 2, embodiments absorb tolerances of dimensional shape and assembly of the contact 2, the housing 10, the mating partners 3-1 and 3-2, or other components through a displacement of the contact 2.

While being retained in the housing body 11 by the engaging pin 11, the contact 2 is allowed to undergo a slide displacement in a direction D2 (direction of slide D2) parallel with the second axis line L2 while being guided by the engaging pin 111. In addition, the contact 2 is also allowed to undergo a rotational displacement in a direction of rotation D1 on the first axis line L1.

The contact 2 indicated by “N” in FIG. 2 is positioned in a design normal position (design position) on an x-y plane. In terms of design, the first mating partner 3-1 is inserted into or removed from the first mating portion 21 of the contact 2, which is positioned in the design position, from a direction parallel with a third axis line L3 orthogonal to the second axis line L2 on the x-y plane.

Similarly, in terms of design, the second mating partner 3-2 is inserted into and removed from the second mating portion 22 of the contact 2, which is positioned in the design position, from a direction parallel with a fourth axis line L4.

In an exemplary embodiment, assuming that the third axis line L3 is located at 0°, the fourth axis line L4 is located at 180°.

In various embodiments, when the contact 2 is in the design position, the third axis line L3 and the fourth axis line L4 both coincide with the x direction set in the housing 10. In this case, the second axis line L2 coincides with the y direction.

FIGS. 2 and 3 show, as an example, a state in which all of the contacts 2 the stacked bodies 20 are in phase with each other in the direction of rotation D1 (direction of x rotation) and at the same position as each other in the direction of slide D2. Without being bound by this state, each of the contacts 2 of the stacked bodies 20 can be displaced into any phase in the direction of rotation D1 and any position in the direction of slide D2. In particular, when the contacts 2 are in a no-load state in which they are not mated with the mating partners 3-1 and 3-2, there are typically variations in the positions of the contacts 2 in the direction of rotation D1 and the direction of slide D2.

A configuration of each of the contacts 2 is described in more detail.

The first mating portion 21 is equivalent to an elastic body (spring) including a pair of beams B1 that retain a first mating partner 3-1 therebetween.

As sections or parts set in the pair of beams B1, the first mating portion 21 includes a receiving portion 21A that receives the first mating partner 3-1, a contact portion 21B that is equivalent to a contact point with the first mating partner 3-1, and a guide portion 21C that guides the first mating partner 3-1 toward the contact portion 21B.

In a section of the receiving portion 21A joined to the connecting portion 23, the pair of beams B1 extend from both sides of the connecting portion 23 in the direction of slide D2 to the contact portion 21B with a decreasing dimension between the pair of beams B1.

In an exemplary embodiment, in a no-load state, the contact portion 21B have set therein a gap G1 into which the first mating partner 3-1 is inserted. The dimension between the pair of beams B1 in the guide portion 21C gradually increases in the direction of slide D2 with respect to the gap G1 away from the contact portion 21B.

The pair of beams B1 have such an overall shape as to concavely bend toward each other (inward) at the contact portion 21B. However, the contact portion 21B is not pointed toward the inside, and the pair of two beams B1 convexly and smoothly curve toward each other at the contact portion 21B.

The first mating portion 21 elastically holds retains the first mating partner 3-1, which is inserted into the receiving portion 21A while spreading out the gap G1 of the first contact portion 21B. In order to give the contact portion 21B rigidity needed to sufficiently retain the first mating partner 3-1, the contact portion 21B is formed to be thicker in a direction in which the first mating partner 3-1 is held than other parts of the pair of beams B1.

As many contact points as the number of contacts 2 that are stacked in a stacked body 20 are brought about by the first mating partner 3-1 making contact with each of the respective contact portions 21B of the contacts 2 for conduction. Therefore, the incorporation of the connector 1 into a power circuit can contribute to an increase in current carrying capacity on the basis of a large number of contact points.

Under conditions where a displacement of the contact 2 in the cavity 110 is allowed, the contact portion 21B has ensured therefor a contact load that is greater than a load imposed, for example, by vibrations or impacts during use of a device in which the connector 1 is incorporated. This prevents the contact portion 21B of the contact 2 and the mating partner 3-1 from being displaced during use and keeps them mated with each other.

The guide portion 21C guides the mating partner 3-1 toward the contact portion 21B. Since the guide portion 21C spreads toward leading ends 21D of the pair of beams B1, the guide portion 21C can guide the mating partner 3-1 toward the gap G1 of the contact portion 21B.

The greater the distance between the leading ends 21D of the pair of beams B1 in the direction of slide D2 is, the easier it is for the mating partner 3-1 to be captured between the pair of beams B1.

In an exemplary embodiment, the guide portion 21C is positioned over a wide range in the direction of slide D2 as the distance d between the pair of beams B1 at the leading ends 21D exceeds the width of the connecting portion 23 (dimension in the direction of slide D2). When this guide portion 21C comes into contact with the side walls 113 and 115 and the dividing wall 117 due to the displacement of the contact 2, a further displacement of the contact 2 is regulated.

As with the first mating portion 21, the second mating portion 22 too is equivalent to a pair of beams B2 that retain a second mating partner 3-2 therebetween.

In an exemplary embodiment, the first mating portion 21 and the second mating portion 22 are formed with point symmetry with respect to the reference position A and formed with line symmetry with respect to the second axis line L2. Therefore, the second mating portion 22 includes a receiving portion 22A, a contact portion 22B, and a guide portion 22C that are similar in configuration to the receiving portion 21A, the contact portion 21B, and the guide portion 21C of the first mating portion 21. The contact portion 22B too has set therein a gap G2 into which the second mating partner 3-2 is inserted.

Various embodiments makes it possible to, while making it possible to capture the mating partners 3-1 and 3-2 over a wide range in the direction of slide D2 with the guide portion 21C, which is part of the spring, sufficiently absorb tolerances on the basis of the displaceability of the contact 2 retained in the housing 10 and thereby prevent the contact 2 and the mating partners 3-1 and 3-2 from being subjected to excessive stress.

The contact 2 may be given an amount of displacement with a limitation needed for tolerance absorption. In an exemplary embodiment, the amount of displacement of the contact 2 fall within a certain range sufficient for tolerance absorption so that the leading ends 21D of the pair of beams B1 and the leading ends 22D of the pair of beams B2 do not interfere with the mating partners 3-1 and 3-2 due to a displacement of the contact 2 by an amount of displacement well over tolerance.

The amount of displacement of the contact 2 in the direction of slide D2 is restricted to the range of motion of the long hole 230 in the direction of slide D2 with respect to the engaging pin 111. Alternatively, the amount of displacement of the contact 2 in the direction of slide D2 is restricted to the range of motion of the connecting portion 23 between the regulating elements 118 facing each other in the y direction.

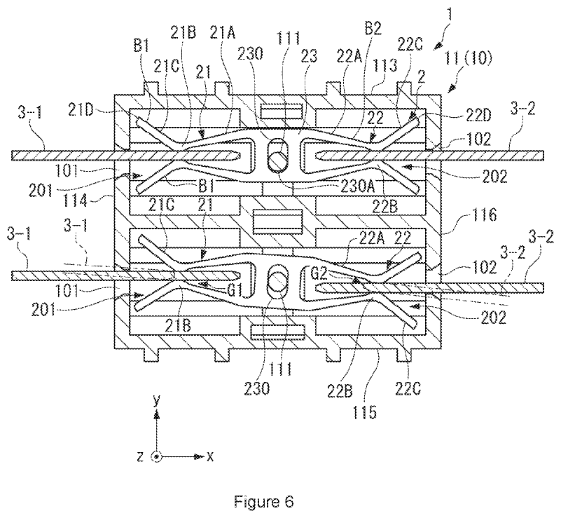

In an exemplary embodiment, the latter applies, as the range of motion of the connecting portion 23 is smaller than the range of motion of the long hole 230. This is merely an example. As in the case of the contact 2 shown on the upper side on the paper surface of FIG. 6, the connecting portion 23 comes into contact with the regulating elements 118 before the engaging pin 111 and the end portion 230A of the long hole 230 come into contact with each other; therefore, a further displacement of the contact 2 is regulated.

The amount of displacement of the contact 2 in the direction of rotation D1 is restricted to the ranges of motion of the mating portions 21 and 22 between the long-side side wall 113 (or side wall 115) and the dividing wall 117, which function as the first regulating element.

For example, if, as indicated by “N” in FIG. 2, the contact 2 undergoes a rotational displacement from a state in which the contact 2 is in the design position to a state shown between the side wall 115 and the dividing wall 117 so that the first mating portion 21 comes into contact with the dividing wall 117 and the second mating portion 22 comes into contact with the side wall 115, the contact 2 is not further displaced in the direction of rotation D1. At this point in time, the displacement of the contact 2 in the direction of slide D2 is regulated too. Assuming that the contact 2 serves as a reference when it is in the design position (N), the amount of rotational displacement of the contact 2 on the engaging pin 111 is regulated within a certain angular range □ to both sides in the direction of rotation D1 with reference to the design position (N).

Depending on the position of the contact 2 in the direction of slide D2 with respect to the engaging pin 111, the rotational displacement of the contact 2 is regulated by only either the first or second mating portion 21 or 22 of the contact 2 positioned between the dividing wall 117 and the side wall 115 (e.g. the first mating portion 21) coming into contact with a regulating wall (e.g. the dividing wall 117). At this point in time, the contact 2 is allowed to be displaced to one side (e.g. the lower side on the paper surface of FIG. 2), as the other of the first and second mating portions 21 and 22 (e.g. the second mating portion 22) is not in contact with the regulating wall.

When the displacement of the contact 2 is regulated by the housing body 11 coming into contact with the displaceable contact 2, the site of contact between the housing body 11 and the contact 2 and the orientation of displacement of the contact 2 that is regulated by the contact between the housing body 11 and the contact 2 change according to various concrete shapes that the housing body 11 and the contact 2 may take. In an exemplary embodiment, the displacements of the contact 2 in the direction of rotation D1 and the direction of slide D2 are regulated as the whole of the side walls 113 and 115 and the dividing wall 117, which are capable of coming into contact with the guide portions 21C and 22C of the contact 2, and the regulating elements 118, which are capable of coming into contact with the connecting portion 23 of the contact 2.

Depending on the respective shapes of the housing body 11 and the contact 2, the displacement of the contact 2 in the direction of rotation D1 may be regulated by contact between the regulating elements 118 and the connecting portion 23.

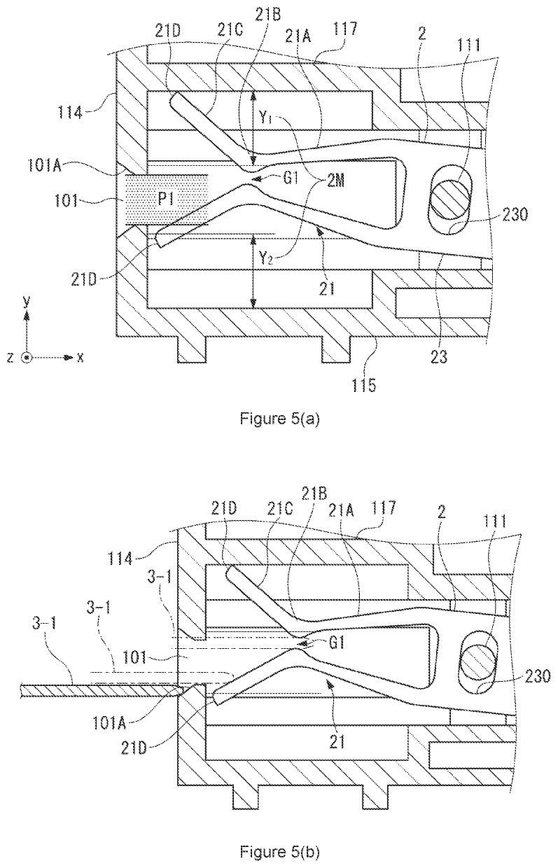

In an exemplary embodiment, as shown in FIG. 5(a), the whole of the range of motion 2M of the pair of beams B1 at the leading ends 21D in the direction of rotation D1 and the direction of slide D2 with respect to the engaging pin 111 be set outside the range of projection P1 of the first opening 101 of the housing 10 in the x direction by the amount of displacement of the contact 2 in the direction of rotation D1 and the direction of slide D2 being restricted by the side walls 113 and 115, the dividing wall 117, and the regulating elements 118 of the housing body 11.

Although not illustrated, the range of motion of the pair of beams B2 of the second mating portion 22 and the range of projection of the second opening 102 are symmetrical with their counterparts shown in FIG. 5(a). As described above, the whole range of motion of the pair of beams B2 at the leading ends 22D may be set outside the range of projection of the second opening 102 projected in the x direction onto the cavity 110.

FIG. 5(a) shows a state in which the leading end 21D of one of the pair of beams B1 of the first mating portion 21 has been maximally displaced to the upper side of the paper surface to the position of the side wall 113. At this point in time, the leading end 21D of the other of the pair of beams B1 is located outside the range of projection P1 while in closest proximity to the first opening 101. Therefore, there is no obstacle to receiving the first mating partner 3-1 between the pair of beams B1 through the first opening 101 and mating the first mating partner 3-1 with the first mating portion 21.

For example, as shown in FIG. 5(b), the first mating partner 3-1 is inserted into the first opening 101 without being interfered with by the pair of beams B1. Moreover, the first mating partner 3-1 reaches the receiving portion 21A by spreading out the gap G1 while pushing the guide portion 21C to displace the guide portion 21C downward on the paper surface by at least either a rotational displacement or slide displacement of the contact 2. By thus allowing the contact 2 to be displaced in the process of insertion, the mating partner 3-1 can be inserted into the mating portion 21 with reduced stress on the contact 2 and the mating partner 3-1.

The mating partner 3-1 may be inserted into the mating portion 21 from any of various directions, as the first mating partner 3-1 may assume any of various positions with respect to the contact 2. The contact portion 21B is given a smoothly curved shape so that the mating partner 3-1 can be received into the gap G1 from any of the various directions and the contact portion 21B and the mating partner 3-1 can be appropriately brought into contact with each other. The same applies to the contact portion 22B of the second mating portion 22.

In an exemplary embodiment, the engagement of the engaging pin 111 with the long hole 230 makes it possible to cause the contact 2 to be displaced in the direction of rotation D1 and the direction of slide D2 by following the mating partners 3-1 and 3-2. This makes it possible to, as shown, for example, in FIG. 6, mate the mating partners 3-1 and 3-2 with the socket 201 formed by the first mating portion 21 and the socket 202 formed by the second mating portion 22, respectively, while absorbing assembly tolerances of dimensional shape and assembly of elements and preventing the contact 2 and the mating partners 3-1 and 3-2 from being subjected to excessive stress.

The mating partners 3 are not necessarily positioned parallel to the x direction, and may be inclined with respect to the x direction as indicated by chain double-dashed lines. Even in such a case, the mating partners 3-1 and 3-2 can be smoothly inserted into the first mating portion 21 and the second mating portion 22, respectively, by the contact 2 being displaceable in a synthetic direction of the direction of rotation D1 and the direction of slide D2.

If the contact 2 is not displaced from the design position, a mating partner 3-1 captured between the pair of beams B1 and guided toward the contact portion 21B by the guide portion 21C cannot be smoothly received into the contact portion 21B or the receiving portion 21A, so that excessive stress may be applied.

If the contact 2 is displaceable but is displaced only in the direction of rotation D1, a mating partner 3-1 positioned particularly along the x direction cannot be smoothly received, so that excessive stress may be applied.

In an exemplary embodiment, even in the case of mating partners 3-1 and 3-2 shifted in they direction as in the case of mating partners 3-1 and 3-2 mated with the contact 2 shown on the lower side on the paper surface of FIG. 6, a rotational displacement and a slide displacement of the contact 2 makes it possible to stably connect the mating partners 3-1 and 3-2 to the first mating portion 21 and the second mating portion 22, respectively, while preventing the contact 2 and the mating partners 3-1 and 3-2 from being subjected to excessive stress.

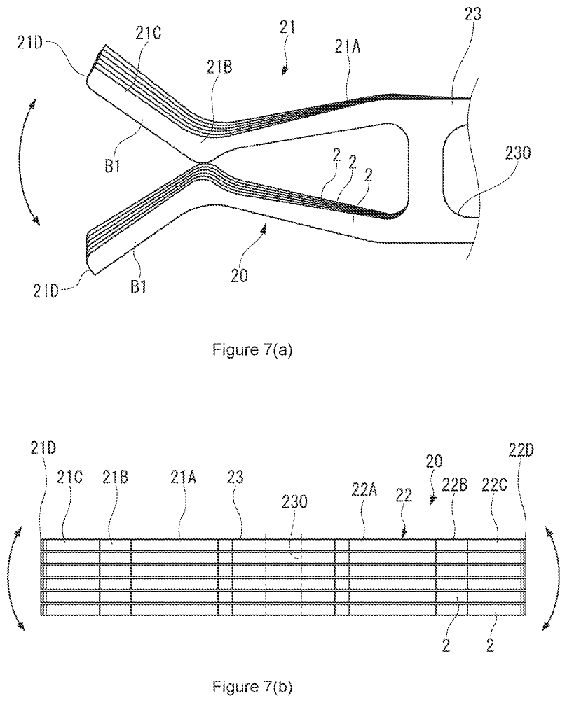

The contacts 2 of a stacked body 20 can be displaced to spread like a fan in the direction of rotation D1 as shown, for example, in FIG. 7(a) and, although not illustrated, can be displaced to spread in the direction of slide D2, and tolerances can be absorbed by such displacement behavior. For example, thought is given to a case where a mating partner 3-1 inclined with respect to the stacking direction (z direction) is inserted into the socket 201. In that case, the mating partner 3-1 can be inserted into the socket 201 by displacing the first mating portion 21 of each contact 2 as shown, for example, in FIG. 7(a) in conformance with the mating partner 3-1.

Furthermore, as shown in FIG. 7(b), the respective mating portions 21 and 22 of stacked contacts 2 are displaced by warpage so that the leading ends 21D and 22D open in a direction along the stacking direction (z direction), whereby tolerances can be absorbed by causing the contacts 2 to follow the mating partners 3-1 and 3-2 as the whole of the stacked body 20.

The mating portions 21 and 22 can be three-dimensionally displaced and deformed in any of the z direction, the direction of rotation D1, and the direction of slide D2.

Other than those above, the components described herein can be accepted or rejected or may be appropriately replaced by other components without departing from the scope of the subject matter described herein. Contacts 2 accommodated in the housing 10 do not need to be stacked. Even in a case where only a single contact 2 is accommodated in the housing 10, working effects substantially the same as those described herein can be brought about. In a case where only a single contact 2 is accommodated in the housing 10, the contact 2 may be given a degree of freedom in a direction along the second axis line L2 by forming, in the housing 10, a long hole that extends parallel to the second axis line L2 when the contact 2 is positioned in a state indicated by “N”, for example, in FIG. 3 and providing the contact 2 with a projecting engaging portion that is inserted into the long hole.

In various embodiments, contacts 2 are stacked, and one stacked body 20 forms one position as a whole. This is not intended to impose any limitation, but contacts 2 may be applied to a multiposition connector. In that case, a single contact 2 or a plurality of contacts 2 stacked are accommodated in each of a plurality of cavities of a connector housing. In the case of such a multiposition configuration, engaging pins formed separately in each of the connecting portions 23 of a plurality of contacts 2 may be passed through long holes of a connector housing, or an engaging pin 111 common to a plurality of contacts 2 may be passed through a long hole 230 of the connecting portion 23 of each contact 2.

The first mating portion 21 and the second mating portion 22 do not necessarily need to be positioned with 180-degree inverted orientation from each other. A case is allowed where a third axis line L3 set in the first mating portion 21 and a fourth axis line L4 set in the second mating portion 22 form an angle of, for example, 160-degree.

Further, the contact 2 may include a third mating portion in addition to the first mating portion 21 and the second mating portion 22.

A single contact 2 or stacked contacts 2 are not only necessarily incorporated into the housing 10 for use but also may be assembled to an appropriate supporting medium for use. The supporting medium may be the housing body 11 shown in FIG. 1. Alternatively, the supporting medium may be one that includes only an engaging pin 111 and nearby components. Such a supporting medium includes, for example, an engaging pin 111, is assembled to the connecting portions 23 of contacts 2 stacked, and keeps the contacts 2 stacked.

The supporting medium and a stacked body 20 made from contacts 2 can be provided as a contact assembly. In a case where the supporting medium does not include a housing body 11, the corresponding mating partners 3-1 and 3-2 can be directly inserted into the first mating portion 21 and the second mating portion 22 without passing through the openings 101 and 102.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A contact shaped like a plate forming a first socket and a second socket for use in mating, the contact comprising:
a first mating portion that constitutes the first socket and that is positioned toward a first side with respect to a reference position;
a second mating portion that constitutes the second socket and that is positioned toward a second side with respect to the reference position; and
a connecting portion, positioned at the reference position, that connects the first mating portion and the second mating portion to each other,
the contact being allowed to be displaced with respect to an engaging portion in both a direction of rotation on a first axis line set along a plate thickness direction of the contact at the reference position and a direction parallel with a second axis line diving the first side and the second side from each other at the reference position, the engaging portion engaging with the connecting portion.

2. The contact according to claim 1, wherein the connecting portion has formed therein a long hole that includes the reference position and that is long in the direction parallel with the second axis line.

3. The contact according to claim 1, wherein:
the first mating portion is an elastic body including a first pair of beams that retain a first mating partner therebetween and includes a first contact portion that makes contact with the first mating partner and a first guide portion that guides the first mating partner toward the first contact portion,
the second mating portion is an elastic body including a second pair of beams that retain a second mating partner therebetween and includes a second contact portion that makes contact with the second mating partner and a second guide portion that guides the second mating partner toward the second contact portion,
a dimension of the first guide portion between the first pair of beams increases in the direction parallel with the second axis line away from the first contact portion, and
a dimension of the second guide portion between the second pair of beams increases in the direction parallel with the second axis line away from the second contact portion.

4. The contact according to claim 3, wherein:
the first pair of beams smoothly curve convexly toward each other at the first contact portion, and
the second pair of beams smoothly curve convexly toward each other at the second contact portion.

5. A connector comprising:
a contact shaped like a plate forming a first socket and a second socket for use in mating, the contact including a first mating portion that constitutes the first socket and that is positioned toward a first side with respect to a reference position, the contact including a second mating portion that constitutes the second socket and that is positioned toward a second side with respect to the reference position, and the contact including a connecting portion, positioned at the reference position, that connects the first mating portion and the second mating portion to each other, wherein the contact is allowed to be displaced with respect to an engaging portion in both a direction of rotation on a first axis line set along a plate thickness direction of the contact at the reference position and a direction parallel with a second axis line diving the first side and the second side from each other at the reference position, the engaging portion engaging with the connecting portion, wherein the contact includes a single contact or a plurality of contacts forming the first socket and the second socket in a stacked state; and
a housing retaining the contact, the housing including a cavity that accommodates the contact, and the housing including an engaging portion that engages with the connecting portion of the contact.

6. The connector according to claim 5, wherein:
the connecting portion has formed therein a long hole that includes the reference position and that is long in the direction parallel with the second axis line, and
the engaging portion is equivalent to a pin that is inserted into the long hole.

7. The connector according to claim 5, wherein the housing includes a first opening through which a first mating partner corresponding to the first mating portion is inserted and a second opening through which a second mating partner corresponding to the second mating portion is inserted.

8. The connector according to claim 5, wherein the housing includes a regulating portion that regulates a displacement of the contact in the direction of rotation on the first axis line within a certain range by coming into contact with the contact and that regulates a displacement of the contact in a direction parallel with the second axis line by coming into contact with the contact.

9. The connector according to claim 8, wherein:
the housing includes a first opening through which a first mating partner corresponding to the first mating portion is inserted and a second opening through which a second mating partner corresponding to the second mating portion is inserted,
in a first contact portion equivalent to a contact point of the first mating portion, a first gap into which the first mating partner is inserted is set,
in a second contact portion equivalent to a contact point of the second mating portion, a second gap into which the second mating partner is inserted is set,
regulating the displacement of the contact through the regulating portion causes a range of motion of a leading end of the first mating portion to be set outside a range of projection of the first opening and causes a range of motion of a leading end of the second mating portion to be set outside a range of projection of the second opening.

10. The connector according to claim 5, wherein the connecting portion has formed therein a long hole that includes the reference position and that is long in the direction parallel with the second axis line.

11. The connector according to claim 5, wherein:
the first mating portion is an elastic body including a first pair of beams that retain a first mating partner therebetween and includes a first contact portion that makes contact with the first mating partner and a first guide portion that guides the first mating partner toward the first contact portion,
the second mating portion is an elastic body including a second pair of beams that retain a second mating partner therebetween and includes a second contact portion that makes contact with the second mating partner and a second guide portion that guides the second mating partner toward the second contact portion,
a dimension of the first guide portion between the first pair of beams increases in the direction parallel with the second axis line away from the first contact portion, and
a dimension of the second guide portion between the second pair of beams increases in the direction parallel with the second axis line away from the second contact portion.

12. The connector according to claim 11, wherein:
the first pair of beams smoothly curve convexly toward each other at the first contact portion, and
the second pair of beams smoothly curve convexly toward each other at the second contact portion.

13. A contact assembly comprising:
a contact shaped like a plate forming a first socket and a second socket for use in mating, the contact including a first mating portion that constitutes the first socket and that is positioned toward a first side with respect to a reference position, the contact including a second mating portion that constitutes the second socket and that is positioned toward a second side with respect to the reference position, and the contact including a connecting portion, positioned at the reference position, that connects the first mating portion and the second mating portion to each other, wherein the contact is allowed to be displaced with respect to an engaging portion in both a direction of rotation on a first axis line set along a plate thickness direction of the contact at the reference position and a direction parallel with a second axis line diving the first side and the second side from each other at the reference position, the engaging portion engaging with the connecting portion, wherein the contact includes a single contact or a plurality of contacts forming the first socket and the second socket in a stacked state; and
a support medium that includes the engaging portion and, by being assembled to the connecting portions of the plurality of contacts, maintains the contacts in a stacked state.

14. The contact assembly according to claim 13, wherein the connecting portion has formed therein a long hole that includes the reference position and that is long in the direction parallel with the second axis line.

15. The contact assembly according to claim 13, wherein:
the first mating portion is an elastic body including a first pair of beams that retain a first mating partner therebetween and includes a first contact portion that makes contact with the first mating partner and a first guide portion that guides the first mating partner toward the first contact portion,
the second mating portion is an elastic body including a second pair of beams that retain a second mating partner therebetween and includes a second contact portion that makes contact with the second mating partner and a second guide portion that guides the second mating partner toward the second contact portion,
a dimension of the first guide portion between the first pair of beams increases in the direction parallel with the second axis line away from the first contact portion, and
a dimension of the second guide portion between the second pair of beams increases in the direction parallel with the second axis line away from the second contact portion.

16. The contact assembly according to claim 15, wherein:
the first pair of beams smoothly curve convexly toward each other at the first contact portion, and
the second pair of beams smoothly curve convexly toward each other at the second contact portion.
